(19) United States
(12) Patent Application Publication
(10) Pub. No.: US 2009/0037860 A1
(43) Pub. Date: Feb. 5, 2009

(54) Apparatus, system and method for simulating operation of circuit

(76) Inventor: Koji Kanno, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/219,134

(22) Filed: Jul. 16, 2008

(30) Foreign Application Priority Data
Jul. 31, 2007 (JP) 2007-198571

(51) Int. Cl. G06F 17/50

(52) U.S. Cl. 716/6

(57) ABSTRACT

An apparatus, includes an analyzing unit which simulates a clock skew of a circuit including a macro block, the macro block including a circuit element, and a macro clock delay store element which stores a macro clock delay corresponding to the macro block, the macro clock delay indicating a delay of a clock signal passing through the macro block. The analyzing unit simulates the clock skew of the circuit by using the macro clock delay.

### INCORPORATION BY REFERENCE

This application is based upon and claims the benefit of priority from Japanese patent application No. 2007-198571, filed on Jul. 27, 2007, the disclosure of which is incorporated herein in its entirety by reference.

### BACKGROUND OF THE INVENTION

1. Field of the Invention

The present invention relates to an apparatus, system and method for verifying operation of a circuit and, more particularly, to an apparatus, system and method for verifying operation timing of signal passes of the circuit.

2. Description of Related Art

In the design of the circuit, the operation verification of signal passes is performed by a timing simulation. It is desired that the timing simulation of the circuit be carried out efficiently and with good accuracy. A timing simulation of the circuit for performing a timing simulation efficiently and with good accuracy is described in Patent Document 1.

In recent years, a macro has sometimes been used in the layout of the circuit. A macro is composed of a plurality of cells. The cells constituting macros constitute a large-scale circuit having a prescribed function. A macro is, for example, a circuit itself of a CPU core, a RAM and the like, and a circuit including a macro. Factors behind the use of macros are the fact that the scale of the circuit has become large and the fact that it is desired to increase the efficiency of the design of the circuit. In the design of the circuit, a large-scale circuit can be easily designed by combining macros having necessary functions.

A method of accurately and easily verifying the operation timing of a circuit including macros is described in Patent Document 2. In this method, in performing a static timing analysis on a gate level, the delay of macros such as RAMs is analyzed by using a library of internal delay values (a macro timing model). The macro delay library has information regarding the internal delay value of each of the macros.

[Patent Document 1] Japanese Patent Laid-Open No. 9-319776

[Patent Document 2] Japanese Patent Laid-Open No. 2001-273338

Generally, in the physical design and delay design of a synchronization circuit, clock distribution design and the delay design of signal passes are separately processed for the sake of convenience of a design procedure. In this case, the clock distribution design is performed so that a clock skew, that is a clock distribution delay difference, becomes close to 0 as much as possible. And, in the delay design of signal passes, on the assumption that the clock skew is sufficiently decreased by the clock distribution design, the delay of the signal pass is improved so that a pass delay becomes within a prescribed clock cycle.

In the macro delay library of a related art that is used in the operation timing verification of the circuit including a macro, a value obtained by adding the delay time of clock signal distribution inside the macro to the setup/hold time of an FF (a flip-flop) located inside the macro is defined as the “setup/hold time of the macro delay library”. The delay time of clock signal distribution inside the macro and the output delay time of the FF located inside the macro are defined as the “delay time of the macro delay library”. In other words, in the macro delay library of the related art, the internal delay value of the macro includes the delay time of clock signal distribution inside the macro. The delay time of clock signal distribution inside the macro unit is the delay time that elapses until a clock signal passes from a clock terminal of the macro through a clock distribution path located inside the macro and reaches a clock terminal of the FF located inside the macro.

Because in the macro delay library of the related art, the setup/hold time is defined as a value obtained by adding the delay time of clock signal distribution inside the macro to the setup/hold time of the FF (a flip-flop) located inside the macro, in the operation timing verification of the signal pass including the macro, for example, for the signal pass whose start point is the macro and whose end point is the FF, it is impossible to take out only the delay time of clock signal distribution inside the macro from the macro delay library.

For this reason, the delay time of clock signal distribution inside the macro is calculated as the delay time of the signal pass, and it has not been considered in the calculation of a clock skew. In other words, the delay time of clock signal distribution inside the macro cannot be calculated separately (e.g., independently) from the delay time of the signal pass. Therefore, in the related art, it is impossible to output, in clock skew information, a true clock skew (i.e., a difference between the delay time that elapses until the clock signal passes from the source of clock signal through the clock distribution path located inside the macro which is a start point of the signal path and reaches a clock terminal of the FF located inside the macro, and the delay time that elapses until the clock signal reaches a clock terminal of the FF which is an end point of the signal path).

As a result, even when clock skew information is referred to, it is impossible to obtain a value of the true clock skew. In making improvements in pass delay, it is impossible to make a judgment such that the clock signal path is improved if the value of the clock skew is large and another signal path (i.e., which is other than the clock signal path), is improved if the value of the clock skew is small. Thus, it has been difficult to make rapid and appropriate improvements in delay.

### SUMMARY OF THE INVENTION

According to one exemplary aspect of the present invention, an apparatus, includes: an analyzing unit which simulates a clock skew of a circuit including a macro block, the macro block comprises a circuit element, and a macro clock delay store element which stores a macro clock delay corresponding to the macro block, the macro clock delay indicating the delay of a clock signal passing through the macro block, wherein the analyzing unit simulates the clock skew of the circuit by using the macro clock delay.

According to another exemplary aspect of the present invention, a system, includes: an analyzing unit which simulates a clock skew of a circuit including a macro block, the macro block comprises a circuit element, and a macro clock delay store element which stores a macro clock delay corresponding to the macro block, the macro clock delay indicating the delay of a clock signal passing through the macro block, wherein the analyzing unit simulates the clock skew of the circuit by using the macro clock delay.

According to another exemplary aspect of the present invention, a method for verifying an operation of a circuit including a macro block which comprises a circuit element, includes: referring to a macro clock delay corresponding to the macro block, the macro clock delay indicating the delay of a clock signal passing through the macro block, and simulating a clock skew of the circuit by using the macro clock delay.

### BRIEF DESCRIPTION OF THE DRAWINGS

Other exemplary aspects and advantages of the invention will be made more apparent by the following detailed description and the accompanying drawings, wherein:

FIG. 1 is a block diagram showing the configuration of an operation timing verification apparatus in an exemplary embodiment of the present invention;

FIG. 2 is a block diagram showing the configuration of a circuit to be verified;

FIG. 3 is a block diagram showing an internal configuration of a macro;

FIG. 4 is a block diagram showing the configuration of a macro delay library;

FIG. 5 is a diagram showing an example of a delay time table in the exemplary embodiment of the present invention;

FIG. 6 is a diagram showing an example of a delay time table in a related art;

FIG. 7 is a diagram showing an example of an output transition time table;

FIG. 8 is a diagram showing an example of a setup time table in the exemplary embodiment of the present invention;

FIG. 9 is a diagram showing an example of a setup time table in a related art;

FIG. 10 is a diagram showing an example of a hold time table in the exemplary embodiment of the present invention;

FIG. 11 is a diagram showing an example of a hold time table in the related art;

FIG. 12 is a diagram showing an example of a macro clock delay library;

FIG. 13 is a diagram showing a timing verification error report;

FIG. 14 is a flowchart showing an operation procedure of the operation timing verification;

FIG. 15 is a diagram showing a first example of a timing verification error report in the exemplary embodiment of the present invention;

FIG. 16 is a diagram showing a first example of a timing report in the related art;

FIG. 17 is a block diagram showing the configuration of another circuit to be verified;

FIG. 18 is a diagram showing a second example of a timing verification error report in the exemplary embodiment of the present invention;

FIG. 19 is a diagram showing a second concrete example of a timing verification error report in the related art.

### DETAILED DESCRIPTION OF THE EXEMPLARY EMBODIMENTS

The present invention has as an exemplary feature the provision of an apparatus, method and program for verifying operation timing capable of a clock skew calculation in which clock delay time within a macro is considered in the operation verification of a semiconductor integrated circuit including the macro.

In the operation timing verification apparatus, method and program of the present invention, it is possible to calculate a clock skew in which a clock delay time within a macro can be calculated in the operation verification of a semiconductor integrated circuit including the macro.

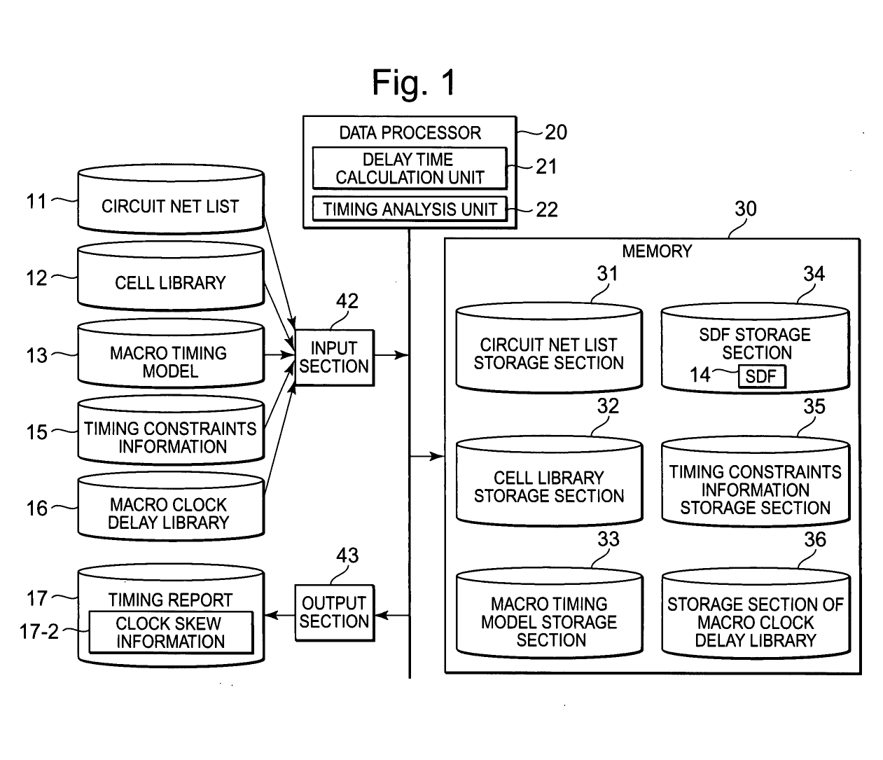

An exemplary embodiment of the present invention will be described below in detail with reference to the drawings. FIG. 1 shows a configuration of an operation timing verification apparatus in an exemplary embodiment of the present invention. The operation timing verification apparatus is provided with a data processor (a computer) 20 that operates under program control and a memory 30 such as a hard disk. The data processor 20 connects with the memory 30 via a bus 41. The data processor 20 connects with an input section 42 that performs data input and an output section 43 that performs data output via the bus 41.

The data processor 20 has delay time calculation unit 21 and timing analysis unit 22 which is capable of considering the delay of a clock signal passing through an inside of the macro block (hereinafter simply “called timing analysis unit”). The memory 30 has a circuit net list storage section 31, a cell library storage section 32, a timing model storage section 33, a SDF (standard delay format) storage section 34, a timing constraints information storage section 35, and a storage section of macro clock delay library 36. An SDF (Standard Delay Format) is a format of a file that stores interconnect delay information and gate delay information for each network, which are calculated by a delay calculation. An SDF is an industry standard. This exemplary embodiment will be described on the basis of an example in which an SDF is used as a file format.

The delay time calculation unit 21 performs a delay calculation by a resistor-capacitor circuit (RC) simulation by inputting a circuit net list (circuit configuration information) 11 and referring to a cell library 12 and a macro delay library 13, generates an SDF 14, and stores the generated SDF 14 in the SDF storage section 34.

The timing analysis unit 22 performs a calculation of the delay time of a signal pass, a calculation of the delay time of a clock pass and a calculation of a clock skew and makes a check as to whether or not the clock pass delay time and the signal pass delay time meet a delay constraint by inputting the circuit net list 11 and referring to the interconnect delay time information and gate delay time information for each network, which are stored in the SDF storage section 34, a macro clock delay library 16, and delay constraint information 15, and outputs a timing verification error report 17 including clock skew information 17-2.

In the calculation of the delay time of a clock pass and the calculation of a clock skew in the timing analysis unit 22, the calculations are performed by adding the delay time of a clock pass within a macro stored in the macro clock delay library 16 to the delay time of a clock pass. In the clock skew information 17-2, there is outputted a true clock skew calculated by adding the delay time stored in the macro clock delay library 16 to the delay time of a clock pass, i.e., a difference in the delay time that elapses until a signal from a source clock reaches a clock terminal at an actual start-point or end-point FF within the macro.

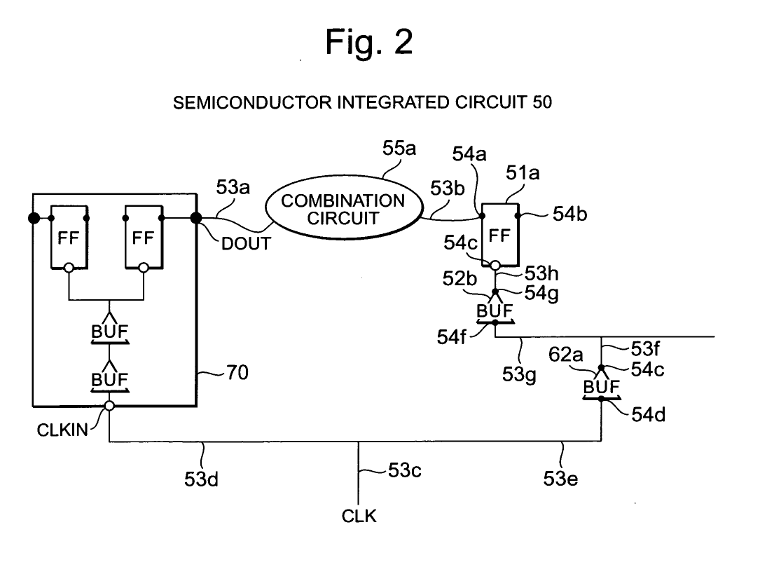

FIG. 2 shows a concrete example of a semiconductor integrated circuit to be verified. This semiconductor integrated circuit 50 includes a macro 70, cells 51a, 52a, 52b, interconnects 53a to 53h, and a combination circuit 55a. The macro 70 is a macro having two buffers and two FFs. The cell type of the cell 51a is a flip-flop (FF) The cell 51a has an input terminal 54a, an output terminal 54b and a clock terminal 54c. The cell type of the cells 52a, 52b is a buffer (BUF).

A signal outputted from an output terminal DOUT of the macro 70 is inputted to the input terminal 54a of the cell 51a via the interconnect 53a, the combination circuit 55a and the interconnect 53b. The cells 52a, 52b have input terminals 54d, 54f and output terminals 54e, 54g, respectively. The semiconductor integrated circuit 50 is a circuit in which these elements are combined as shown in FIG. 2. FIG. 2 also schematically shows a laid-out condition.

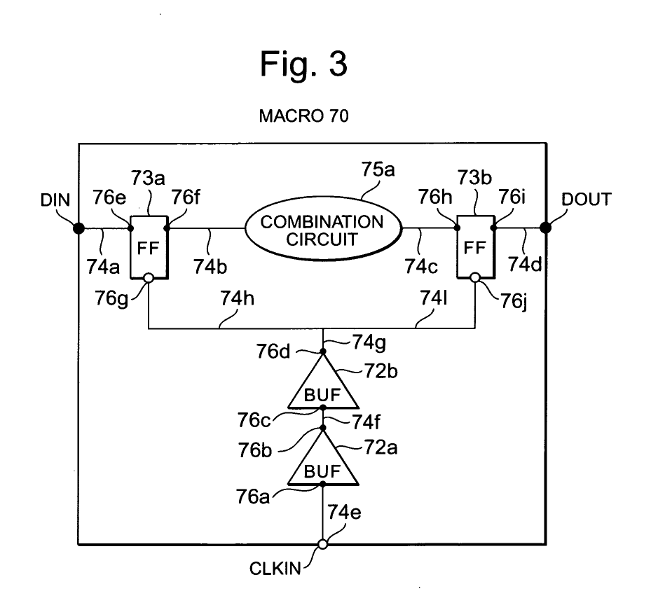

FIG. 3 shows the details of the macro 70. The macro 70 includes cells 72a, 72b, 73a, 73b, interconnects 74a to 74i, and a combination circuit 75a. The cell type of the cell 72a, 72b is a buffer (BUF) The cells 72a, 72b have input terminals 76a, 76c and output terminals 76b, 76d, respectively. The cell type of the cells 73a, 73b is a flip-flop (FF). The cells 73a, 73b have input terminals 76e, 76h, output terminals 76f, 76i, and clock terminals 76g, 76j, respectively. The macro 70 is a circuit in which these elements are combined as shown in FIG. 3.

In the cell library 12 of FIG. 1 are stored the delay time from an input terminal to an output terminal in each of the cells of flip-flop (FF) and the cells of buffer (BUF), the setup time and hold time of a clock signal with respect to a data signal inputted to an input terminal, and the like. For the details of the cell library, explanations are made as a cell library in Japanese Patent Laid-Open No. 2001-273338 and as a timing constraint library in Japanese Patent Laid-Open No. 2006-39621.

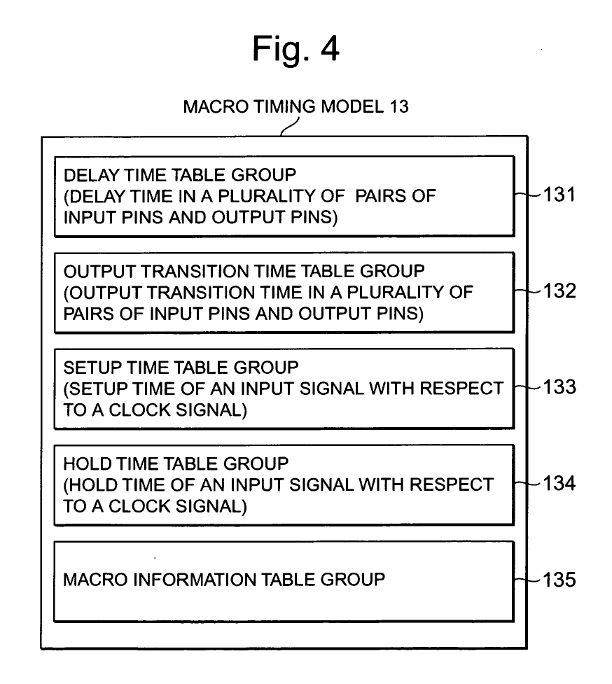

FIG. 4 is a conceptual diagram showing the configuration of the macro delay library 13. The configuration of this library is the same as that of the part of the cell library 12 related to the cell type of flip-flop (FF). The macro delay library 13 includes a delay time table group 131, an output waveform rounding table group 132, a setup time table group 133, a hold time table group 134, and a macro information table group 135.

The delay time table group 131 includes a plurality of “delay time tables.” Each of the delay time tables describes values each obtained by subtracting the clock distribution delay time within a macro from the signal delay time that elapses from a clock terminal CLKIN of the macro to an output terminal DOUT. That is, this table describes the delay time obtained by subtracting a sum of the delay time of the interconnects 74e, 74f, 74g, 74i, and the cells 72a, 72b from the delay time that elapses from the clock terminal CLKIN of the macro 70 (FIG. 3) to the output terminal DOUT.

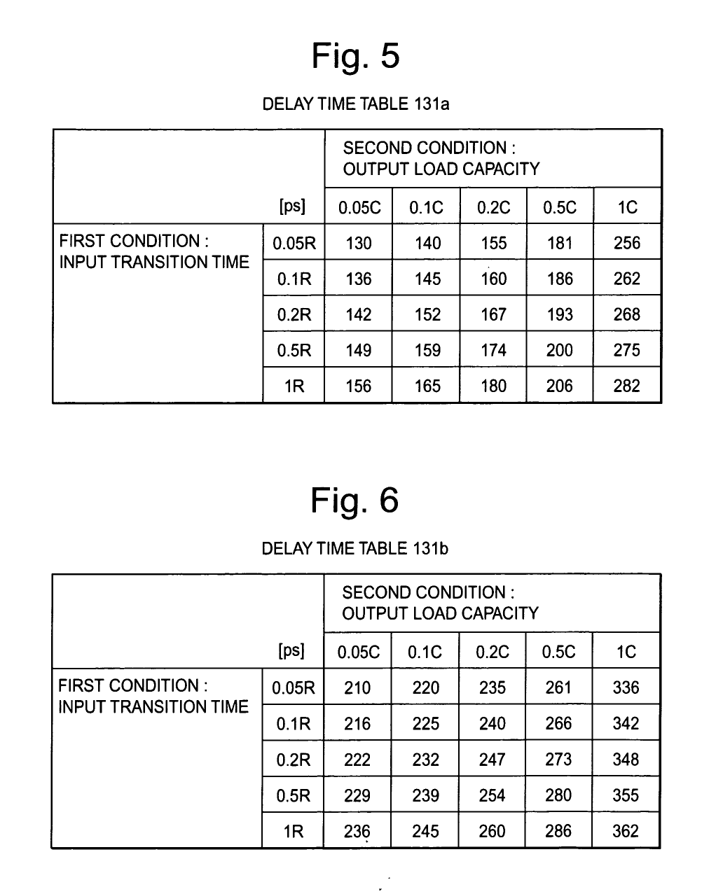

FIG. 5 shows a concrete example 131a of a delay time table 131. This delay time table 131a shows delay time for a plurality of conditions in the form of a table. The plurality of conditions are shown in combinations of a first condition and a second condition.

In this table, the first condition (a first table index) is the “input waveform rounding” showing the degree of the waveform rounding of a signal inputted to the clock terminal CLKIN of the macro. The second condition (a second table index) is an “output load capacity” showing the load capacity applied to the output terminal DOUT. When a macro has a plurality of output terminals DOUT, for one macro, a plurality of delay time tables are prepared so as to correspond to the plurality of output terminals.

In FIG. 5, the plurality of conditions are given as combinations of the first condition (0.05 R to 1R) and the second condition (0.05C to 1C), and the delay time table 131a shows 25 kinds of delay times for each of the combinations. The unit of delay time in the delay time table 131a is [ps]. In consulting the table, in a case where the conditions take on a value between the indexes, an interpolated value is found by interpolation (for example, linear interpolation). The delay time table describes each of a maximum value, a standard value and a minimum value. The delay time table 131a shown in FIG. 5 is a delay time table in which maximum values are described.

FIG. 6 shows a concrete example of a delay time table used in a related art as a comparative example. The table construction of the delay time table 131b used in the related art has the same table construction of the delay time table 131a used in this exemplary embodiment, which is shown in FIG. 5. The delay time table 131b in the related art describes the signal delay time that elapses from the clock terminal CLKIN to the terminal output DOUT, including also the clock distribution delay time within the macro 70. For the clock distribution delay time within the macro 70, i.e., the time that elapses until a clock signal reaches the clock terminal 76j of the FF cell 73b within the macro from the clock terminal CLKIN of the macro 70, it is assumed that a maximum value is 80 [ps] and that a minimum value is 60 [ps]. A comparison between the delay time of the delay time table 131a shown in FIG. 5 and the delay time of the delay time table 131b shown in FIG. 6 reveals that there is a difference equivalent to the clock distribution delay time within the macro (80 [ps]).

The output waveform rounding table group 132 includes a plurality of “output waveform rounding tables.” Each of the output waveform rounding tables shows an output waveform rounding in each input terminal DIN and each output terminal DOUT of a macro and each combination thereof. The output waveform rounding shows the degree of rounding of a signal in a corresponding output terminal DOUT. The output waveform rounding table in this exemplary embodiment describes the same contents as an output waveform rounding table in the related art.

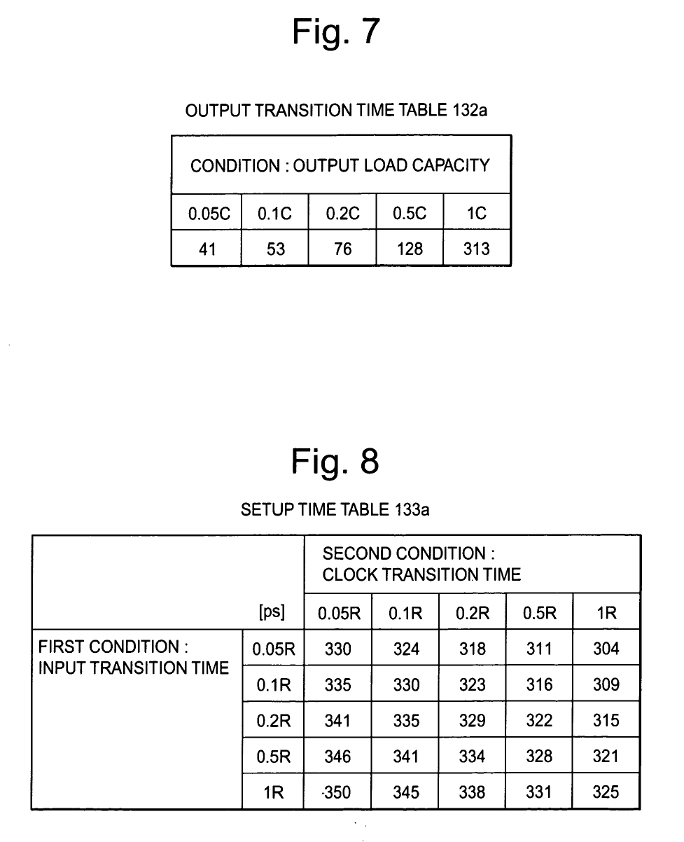

FIG. 7 shows a concrete example 132a of an output waveform rounding table, 132. This output waveform rounding table 132a shows output waveform rounding values for a condition. In this table, the condition (a table index) is the “output load capacity” showing a load capacity applied to an output terminal DOUT. For example, the condition is given as values between 0.05C and 1C, and the output waveform rounding table 132a shows five kinds of output waveform roundings (unit [ps]) for the respective values of the condition. In consulting the table, in a case where the condition takes on a value between the indexes, an interpolated value is found by interpolation (for example, linear interpolation). The output waveform rounding table describes each of a maximum value, a standard value and a minimum value. The output waveform rounding table 132a shown in FIG. 7 is an output waveform rounding table in which maximum values are described.

The setup time table 133 includes a plurality of “setup time tables.” Each of the setup time tables shows values each obtained by subtracting a clock distribution delay time within the macro from the setup time of an input signal inputted to the input terminal DIN of the macro with respect to a clock signal inputted to the clock terminal CLKIN.

That is, this table shows the time obtained by subtracting a sum of the delay time of the interconnects 74e, 74f, 74g, 74h, and the cells 72a, 72b from the setup time of the input terminal DIN of the macro 70 with respect to the clock terminal CLKIN. In order to ensure a normal operation of the macro, before the FF cell 73a within the macro closes a latch under a clock signal CLK, it is necessary that the input of an input signal be started prior to a given time. “Setup time” shows a minimum value of the given time of the input.

FIG. 8 shows a concrete example 133a of a setup time table 133. This setup time table 133a shows setup time for a plurality of conditions in the form of a table. The plurality of conditions are composed of combinations of a first condition and a second condition. In this table, the first condition (a first table index) is the “input waveform rounding” showing the degree of the waveform rounding of a signal inputted to the input terminal DIN. The second condition (a second table index) is the “clock waveform rounding” showing the degree of the waveform rounding of a clock signal inputted to the clock terminal CLKIN. In FIG. 8, the plurality of conditions are given as combinations of the first condition (0.05R to 1R) and the second condition (0.05R to 1R), and the setup time table 133a shows 25 kinds of setup times (unit [ps]) for the combinations. In consulting the table, in a case where the conditions take on a value between the indexes, an interpolated value is found by interpolation (for example, linear interpolation). The setup time table describes each of a maximum value, a standard value and a minimum value. The setup time table 133a shown in FIG. 8 is a setup time table in which maximum values are described.

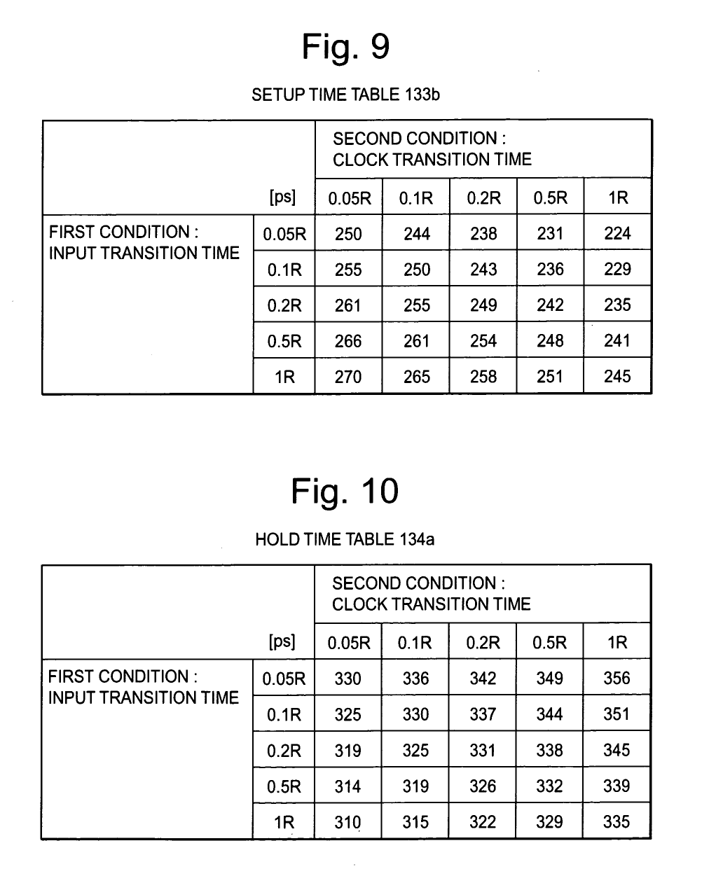

FIG. 9 shows a concrete example of a setup time table used in the related art as a comparative example. The table construction of the setup time table 133b has the same table construction as the setup time table 133a used in this exemplary embodiment, which is shown in FIG. 8. The setup time table 133b in the related art describes the setup time of an input signal inputted to the input terminal DIN with respect to a clock signal inputted to the clock terminal CLKIN, including the clock distribution delay time within the macro 70 (FIG. 3). For the clock distribution delay time within the macro (i.e., the time that elapses until a clock signal reaches the clock terminal 76g of the FF cell 73a within the macro from the clock terminal CLKIN of the macro 70), it is assumed that a maximum value is 80 [ps] and that a minimum value is 60 [ps]. A comparison between the setup time of the setup time table 133a shown in FIG. 8 and the setup time of the setup time table shown in FIG. 9 reveals that there is a difference equivalent to the clock distribution delay time within the macro (80 [ps]).

The hold time table group 134 includes a plurality of “hold time tables.” Each of the hold time tables shows the hold time of an input signal inputted to the input terminal DIN of the macro with respect to a clock signal inputted to the clock terminal CLKIN, not including the clock distribution delay time within the macro. That is, this table shows the hold time obtained by subtracting a sum of the delay time of the interconnects 74e, 74f, 74g, 74h, and the cells 72a, 72b from the hold time of the input terminal DIN of the macro 70 with respect to the clock terminal CLKIN. In order to ensure a normal operation of the macro 70, it is necessary that an input signal be held for a given time after the closing of a latch of the FF cell 73a within the macro 70 under a clock signal CLK. Hold time shows a minimum value of the given time of the holding.

FIG. 10 shows a concrete example 134a of a hold time table 134. This hold time table 134a shows hold time for a plurality of conditions in the form of a table. The plurality of conditions are composed of combinations of a first condition and a second condition.

In this table, the first condition (a first table index) is the “input waveform rounding” showing the degree of the waveform rounding of a signal inputted to the input terminal DIN. The second condition (a second table index) is the “clock waveform rounding” showing the degree of the waveform rounding of a clock signal inputted to the clock terminal. In FIG. 10, the plurality of conditions are given as combinations of the first condition (0.05 R to 1R) and the second condition (0.05R to 1R), and the hold time table 134a shows 25 kinds of hold times (unit [ps]) for the combinations. In consulting the table, in a case where the conditions take on a value between the indexes, an interpolated value is found by interpolation (for example, linear interpolation). The hold time table describes each of a maximum value, a standard value and a minimum value. The hold time table 134a shown in FIG. 10 is a hold time table in which maximum values are described.

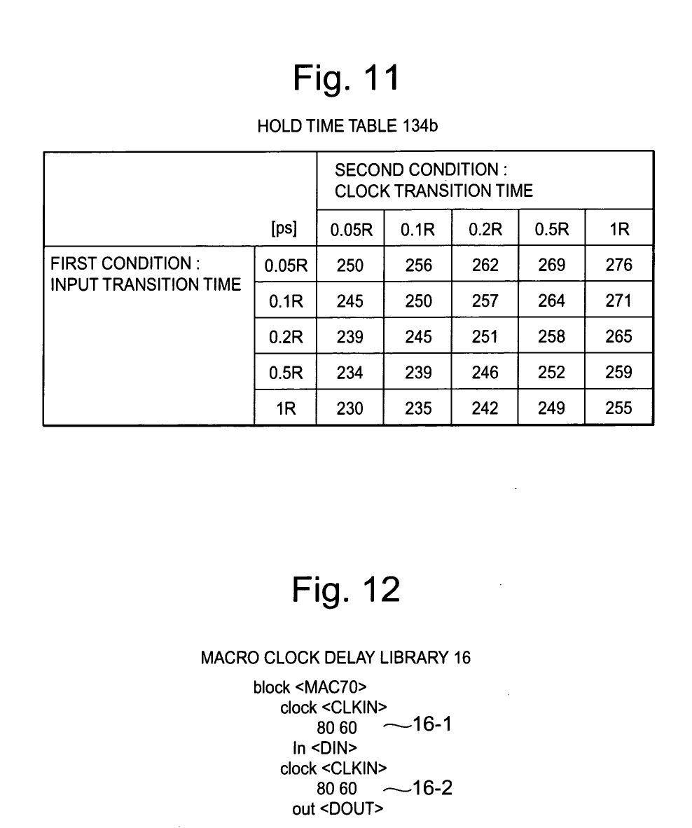

FIG. 11 shows a concrete example of a hold time table used in the related art as a comparative example. The table construction of the hold time table 134b has the same table construction of the hold time table 134a used in this exemplary embodiment, which is shown in FIG. 10. The hold time table 134b in the related art describes the hold time of an input signal inputted to the input terminal DIN with respect to a clock signal inputted to the clock terminal CLKIN, including the clock distribution delay time within the macro 70 (FIG. 3).

As described above, for the clock distribution delay time within the macro (i.e., the time that elapses until a clock signal reaches the clock terminal 76g of the FF cell 73a within the macro from the clock terminal CLKIN of the macro 70), it is assumed that a maximum value is 80 [ps] and that a minimum value is 60 [ps]. A comparison between the hold time of the hold time table 134a shown in FIG. 10 and the hold time of the hold time table 134b shown in FIG. 11 reveals that there is a difference equivalent to the clock distribution delay time within the macro (80 [ps]).

The macro information table group 135 includes a plurality of macro information tables. Each of the macro information tables describes the size of a macro, the capacity of the input terminal DIN, a possible threshold voltage range of the input terminal DIN, the capacity of the clock terminal CLKIN, a possible threshold voltage range of the clock terminal CLKIN, the resistance of the output terminal DOUT and the like. The macro information table used in this exemplary embodiment has the same contents as a macro information table in the related art.

The delay constraint information 15 (FIG. 1) is information that becomes constraint information for operating a semiconductor integrated circuit, such as a basic clock cycle (or a basic clock frequency), delay time outside an input pin, demand delay time outside an output pin, and delay constraint exception passes (false pass, multicycle pass). For example, when it is necessary that operation be finished within one clock cycle, a judgment is made by operation timing verification as to whether or not the operation time is within a basic clock cycle.

The delay time outside an input pin is the delay time that is used in the timing verification of a pass from an external input pin of a semiconductor integrated circuit to a block within the semiconductor integrated circuit, and indicates the delay time from a signal output point of the semiconductor integrated circuit to the external input pin. The delay time outside an output pin is the delay time that is used in the timing verification of a pass from a block within the semiconductor integrated circuit to an external output pin of the semiconductor integrated circuit, and indicates the delay time from the external output pin to a signal input point of the semiconductor integrated circuit.

A false pass belonging to the delay constraint exception pass is intended for specifying a pass for which it is unnecessary to perform timing verification within a semiconductor integrated circuit, and is used when timing verification is carried out by neglecting a specific pass. A multicycle pass belonging to the delay constraint exception pass is intended for specifying a pass for which during timing verification within a semiconductor integrated circuit, it is not necessary that operation be finished within one clock cycle but operation may be finished within two clock cycles or three clock cycles. In the verification of a multicycle pass, for example, a judgment is made as to whether or not the operation time is within a cycle that is twice or three times the basic clock cycle. The delay constraint information 15 is stored beforehand in the timing constraints information storage section 35.

The macro clock delay library 16 describes the delay time of clock distribution within the macro 70. FIG. 12 shows a concrete example of a macro clock delay library. The macro clock delay library 16 includes a line 16-1 and a line 16-2.

The line 16-1 describes the clock pass delay time from the clock terminal CLKIN to the clock terminal 76g of the FF cell 73a on the input terminal DIN side within the macro 70 (i.e., a maximum value and a minimum value of a sum of the delay time of the interconnects 74e, 74f, 74g, 74h, and the cells 72a, 72b).

The line 16-2 describes the clock pass delay time from the clock terminal CLKIN to the clock terminal 76j of the FF cell 73b on the output terminal DOUT side within the macro 70 (i.e., a maximum value and a minimum value of a sum of the delay time of the interconnects 74e, 74f, 74g, 74i, and the cells 72a, 72b).

As described above, for the clock pass delay time from the clock terminal CLKIN to the clock terminal 76g of the FF cell 73a on the input terminal DIN side within the macro 70, a maximum value and a minimum value are 80 [ps] and 60 [ps], respectively. And for the clock pass delay time from the clock terminal CLKIN to the clock terminal 76j of the FF cell 73b on the output terminal DOUT side within the macro 70, a maximum value and a minimum value are 80 [ps] and 60 [ps], respectively. Therefore, the lines 16-1 and 16-2 describe [80] and [60], respectively.

Interconnect delay time and gate delay time for each network calculated by the delay time calculation unit 21 are outputted to the SDF 14. The timing verification error report 17 describes timing verification results, which are the results of a check made to ascertain whether or not clock pass delay time and signal pass delay time meet a delay constraint. The timing verification results include a line 17-2 showing clock skew information calculated by the timing analysis unit 22.

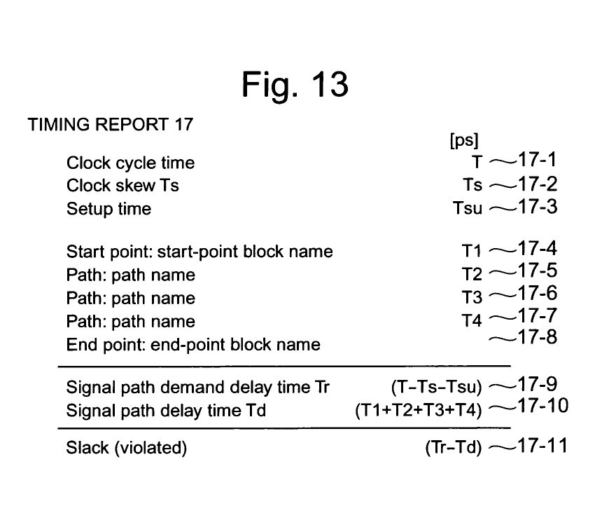

FIG. 13 shows the contents of a timing verification error report. The timing verification error report 17 includes a line 17-1 to a line 17-11.

The line 17-1 describes clock cycle time T. This clock cycle time corresponds to a basic clock cycle in delay constraint information. The line 17-2 describes a clock skew Ts. The line 17-3 describes setup time Tsu in the case of setup timing verification and hold time Thl in the case of hold timing verification. The line 17-4 describes a start-point block name and output delay time of the start-point block. The lines 17-5 to 17-7 each describe an interconnect name and a cell name, which become a path, and the delay time of the interconnect and the cell. The line 17-8 describes an end-point block name.

The line 17-9 describes signal pass demand delay time Tr. The signal pass demand delay time Tr is a value obtained by subtracting clock skew Ts and setup time Tsu from clock cycle time T. Line 17-10 describes signal pass delay time Td. The signal pass delay time Td is a value obtained by adding the delay time T1 at a start point and each of the delay times T2 to T4 of a path. The line 17-11 describes a slack. The slack is a value obtained by subtracting the signal pass delay time Td from the signal pass demand delay time Tr. If a slack is a positive value, then it is judged that there is no violation in the operation timing of a pass. On the other hand, if a slack is a negative value, then it is judged that there is a violation in the operation timing of a pass.

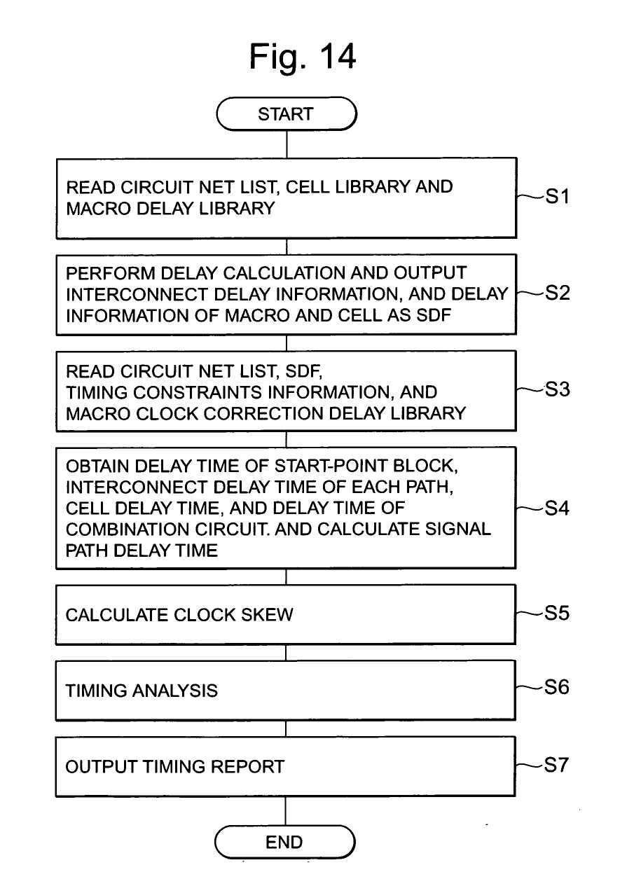

FIG. 14 shows an operation procedure of the operation timing verification apparatus. The delay time calculation unit 21 reads the circuit net list 11, the cell library 12 and the macro delay library 13 (Step S1), performs a delay calculation by an RC simulation, and outputs interconnect delay information and the delay information of a macro and a cell as an SDF (Step S2). The details of Steps S1 and S2 are described in Japanese Patent Laid-Open No. 2001-273338, Japanese Patent Laid-Open No. 2000-259686, Japanese Patent Laid-Open No. 2000-305966, Japanese Patent Laid-Open No. 2000-250950 and the like.

In the delay calculation at Step S2, for example, the output waveform rounding of the macro 70 is found from the output load capacity of the macro 70 by referring to the output waveform rounding table 132a (FIG. 7), and calculates the delay time of the combination circuit 55a by using this output waveform rounding as the input waveform rounding of the combination circuit 55a. The delay calculation at Step S2 is basically the same as an ordinary delay calculation in the related art.

In this exemplary embodiment, however, the delay time table 131a of the macro delay library 13 (FIG. 5) holds values obtained by subtracting the delay time of clock distribution from the delay time of a signal from a clock terminal of a macro to an output terminal and, therefore, the delay time of a macro calculated at Step S2 is a delay time not including the delay time of clock distribution within the macro.

The timing analysis unit 22 reads the circuit net list 11, the SDF 14, the delay constraint information 15, and the macro clock delay library 16 (Step S3). The timing analysis unit 22 obtains the delay time of a start-point block and the delay time of the interconnect of each path and cells and of a combination circuit from the SDF, and finds the delay time of a signal pass (Step S4). At Step S4, for example, the timing analysis unit 22 refers to the SDF 14 generated at Step S2 and obtains the delay time of the macro 70, which is a start-point block, the delay time of the interconnects 53a, 53b, and the delay time of the combination circuit 55a for the semiconductor integrated circuit 50 shown in FIG. 2. After that, the timing analysis unit 22 calculates signal pass delay time Td from the delay time of the start-point block and the delay time of the interconnects of each path and the cells and of the combination circuit, which have been obtained. In the semiconductor integrated circuit 50 shown in FIG. 2, the signal pass delay time Td is a value obtained by adding the delay time of the macro 70 and the delay time of the interconnects 53a, 53b and the combination circuit 55a.

The timing analysis unit 22 calculates a clock skew for a semiconductor integrated circuit to be verified (Step S5). The calculation of a clock skew is concretely performed as follows. In the case of the semiconductor integrated circuit 50 shown in FIG. 2, first, clock delay time Tc1 that elapses until a clock signal CLK reaches the clock terminal CLKIN of the macro 70 is calculated.

This clock delay time Tc1 is a sum of the delay time of the interconnects 53c, 53d. The delay time of each interconnect can be obtained by referring to the SDF 14. Subsequently, clock delay time Tc2 that elapses until the clock signal CLK reaches the clock terminal 54c of the cell 51a is calculated. The clock delay time Tc2 is a sum of the delay time of the cells 52a, 52b and the interconnect delay time of the interconnects 53c, 53e, 53f, 53g, 53h. The delay time of each cell and each interconnect can be obtained by referring to the SDF 14.

The timing analysis unit 22 calculates the clock skew Ts by using the clock delay time Tc1, Tc2, which has been calculated above, and the macro clock delay library 16. The macro clock delay library 16 (FIG. 12) holds the delay time of a clock distribution path for each part within the macro 70. The timing analysis unit 22 obtains, from the macro clock delay library 16, the clock delay time within the macro from the clock terminal CLKIN of the macro 70 to the clock terminal 76j of the FF cell 73b.

The timing analysis unit 22 regards, as the clock skew Ts, a value obtained by subtracting the delay time Tc2 to the cell 61a from a sum of the clock delay time Tc to the macro 70 and the delay time of the clock distribution path within the macro, which has been obtained from the macro clock delay library 16. This clock skew Ts is an actual clock skew (i.e., a difference in the delay time that elapses until a signal from a source clock reaches the clock terminal of an actual start-point or end-point FF within the macro, in which the clock distribution delay within the macro 70 is considered).

The timing analysis unit 22 verifies operation timing by using the signal pass delay time Td calculated at Step S4 and the clock skew Ts calculated at Step S5 (Step S6). In setup timing analysis, the operation timing of a circuit is verified by making a comparison between a value obtained by subtracting a sum of the clock skew Ts and the setup time of the cell 51a from the clock cycle time of the clock signal CLK, which is a delay constraint, i.e., the signal pass demand delay time Tr and the signal pass delay time Td. The clock cycle time of the clock signal CLK is obtained from the delay constraint information 15. The setup time of the cell 51a is obtained from the setup time table of the cell library 12.

In timing analysis, it is judged that there is no violation in operation timing if a slack that is a value obtained by subtracting the signal pass delay time Td from the signal pass demand delay time Tr is a positive value. If this value is a negative value, then it is judged that there is a violation in operation timing and that a delay improvement is necessary.

The timing analysis unit 22 generates the timing verification error report 17 from the results of the timing verification. Concretely, the lines 17-4 to 17-7 in timing verification error report 17 (FIG. 13) describe the delay time of the macro 70, delay time of the interconnects 53a, 53b and delay time of the combination circuit 55a that have been obtained by referring to the SDF 14 at Step S4. The line 17-10 describes the signal pass delay time Td calculated at Step S4. The line 17-2 describes the clock skew Ts calculated at Step S5. The line 17-9 describes the signal pass demand time Tr. The line 17-11 describes a slack (signal pass demand time-signal pass delay time). The timing analysis unit 22 outputs the generated timing verification error report 17 from the output section 43.

The operation timing verification of the semiconductor integrated circuit 50 will be described below by using examples of concrete numerical values. At Step S2, the delay time calculation unit 21 calculates the interconnect delay time of each interconnect and the delay time of the macro and cells.

In the delay time calculation of the macro 70, the delay time calculation unit 21 finds the delay time from the input waveform rounding of a signal inputted to the macro 70 and the output load capacity of the macro 70 by referring to the delay time table 131a (FIG. 5). When the input waveform rounding is “0.2R” and the output load capacity is “0.2C,” the delay time found from the delay time table 131a is “167 [ps].” The delay time calculation unit 21 describes the calculated delay time of each part in the SDF 14 and stores the SDF 14 in the SDF storage section 34.

At Step S4, the timing analysis unit 22 obtains, from the SDF 14, the delay time of the macro 70, the delay time of the interconnects 53a, 53b, and the delay time of the cell 51a and the combination circuit 55a. It is assumed that the delay time of the interconnect 53a is 10 [ps], that the delay time of the combination circuit 55a is 780 [ps], and that the delay time of the interconnect 53b is 10 [ps]. In this case, the timing analysis unit 22 obtains 967 [ps] from a calculation by adding these values of delay time to the delay time 167 [ps] of the macro 70 as the macro pass delay time Td.

Subsequently, the timing analysis unit 22 calculates the clock skew Ts. In the calculation of the clock skew Ts, first, the clock delay time Tc1 of the macro 70 and the clock delay time Tc2 of the cell 51a are found.

The delay time analysis unit 22 obtains the delay time of the interconnects 53c, 53d by referring to the SDF 14, and regards a sum of the two as the clock delay time Tc1 from the clock source to the clock terminal CLKIN of the macro 70.

The delay time analysis unit 22 obtains the delay time of the cells 52a, 52c and the delay time of the interconnects 53c, 53e, 53f, 53g, 53h by referring to SDF 14 and regards a sum of these as the clock delay time Tc2 from the clock source to the clock terminal 54c of the cell 51a. In this case, it is assumed that the clock delay time Tc1 is 10 [ps] and that the clock delay time Tc2 is 90 [ps].

Subsequently, the timing analysis unit 22 finds the clock delay time within the macro 70 by referring to the macro clock delay library 16. More specifically, the timing analysis unit 22 finds the clock delay time from the clock terminal CLKIN of the macro 70 to the clock terminal 76j of the FF cell 73b (FIG. 3) on the output terminal DOUT side by referring to the macro clock delay library 16. In the macro clock delay library 16 shown in FIG. 12, the line 16-2 describes the clock delay time of the FF cell 73b, and the timing analysis unit 22 obtains the clock delay time 80 [ps] of the FF cell 73b from the line 16-2.

The timing analysis unit 22 regards a sum of the macro clock delay time Tc2 of the macro 70 and the clock delay time within the macro 70 as the clock delay time from the clock source to the clock terminal 76j of the FF cell 73b on the output terminal DOUT side in the macro 70. Because the clock delay time Tc1 is 10 [ps] and the clock delay time within the macro 70 is 80 [ps], the clock delay time from the clock source to the clock terminal 76j becomes 90 [ps].

The clock analysis unit 22 regards a value obtained by subtracting the clock delay time Tc2 of the cell 51a from the clock delay time to the clock terminal 76j within the macro 70 as the clock skew Ts. Because the clock delay time to the clock terminal 76j within the macro 70 is 90 [ps] and the clock delay time Tc2 of the cell 51a is 90 [ps], the clock skew Ts becomes 0 [ps].

At Step S6, the timing analysis unit 22 verifies operation timing by using the signal pass delay time Td and the clock skew Ts. In the setup timing analysis, first, the signal pass demand delay time Tr is found. The signal pass demand delay time Tr is defined as a value obtained by subtracting a sum of the clock skew Ts and the setup time Tsu from the clock cycle time T. If the clock cycle time T is 1000 [ps] and the setup time Tsu is 40 [ps], then the clock skew Ts is 0 [ps]. Therefore, the signal pass demand delay time Tr is 960 [ps]. Subsequently, the slack is found by subtracting the signal pass delay time Td from the signal pass demand delay time Tr. Because the signal pass delay time Td is 967 [ps], the slack becomes −7 [ps].

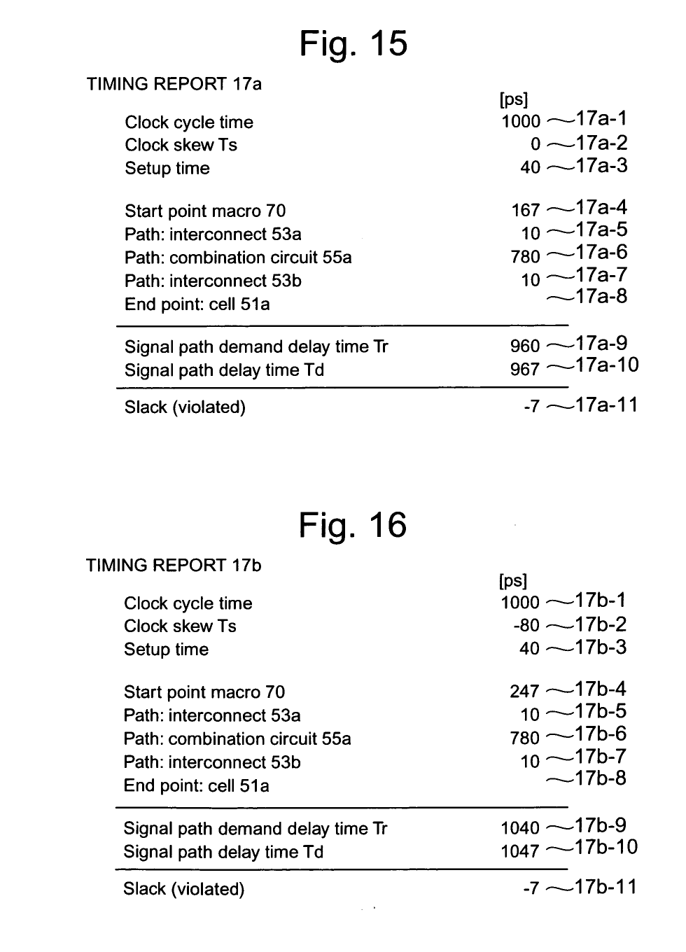

After finishing the operation timing verification, at Step S7 the timing analysis unit 22 generates a timing verification error report 17. FIG. 15 shows a concrete example 17a of a timing verification error report 17. In the timing verification error report 17a, the lines 17a-4 to 17a-8 describe the signal paths from the macro 70, which is a start-point block, to the cell 51a, which is an end-point block. The line 17a-4 describes the delay time (167 [ps]) of the macro 70, the line 17a-5 describes the delay time (10 [ps]) of the interconnect 53a, the line 17a-6 describes the delay time (780 [ps]) of the combination circuit 55a, and the line 17a-7 describes the delay time (10 [ps]) of the interconnect 53b. The line 17a-10 describes the signal pass delay time Td, the value of which is a sum of the delay time described in the lines 17a-4 to 17a-7 (167+10+780+10=967 [ps]).

The line 17a-1 of the timing verification error report 17a describes the clock cycle time T, the value of which is 1000 [ps]. The line 17a-2 describes the clock skew calculated at Step S5, the value of which is 0 [ps]. The line 17a-3 describes the setup time, the value of which is 40 [ps]. The line 17a-9 describes the signal pass demand delay time Tr, the value of which is a value obtained by subtracting a sum of the clock skew Ts of the line 17a-2 and the setup time Tsu of the line 17a-3 from the clock cycle time T of the line 17a-1 (1000−0−40=960 [ps]).

The line 17a-11 is a slack obtained by subtracting the signal pass delay time Td of the line 17a-10 from the signal pass demand delay time Tr of the line 17a-9, the value of which is 960−967=−7 [ps]. If this slack value is a positive value, then it is judged that there is no violation in operation timing, whereas if the slack value is a negative value, then it is judged that an operation timing violation has occurred and that a delay improvement is necessary. In this example, the slack value is a negative value and a delay improvement is necessary.

As a comparative example, the operation timing verification of the semiconductor integrated circuit 50 was carried out by applying the related art. FIG. 16 shows a timing verification error report, which is the result of an operation timing verification in the related art. The clock cycle time T of the line 17b-1 and setup time Tsu of the line 17b-3 in the timing verification error report 17b have the same values as in the timing error verification error report 17a of this exemplary embodiment shown in FIG. 15. Also the delay time of the line 17b-5 to 17b-7 has the same values as in the timing verification error report 17a of this exemplary embodiment shown in FIG. 15.

In the related art, in the delay time calculation of the macro 70, the delay time table 131b (FIG. 6) that holds the delay time including the clock delay time (80 [ps]) within the macro 70 is referred to. When the delay time table 131b is referred to at an input waveform rounding of “0.2R” and an output load capacity of “0.2C,” the delay time of the macro 70 becomes 247 [ps]. Therefore, the delay time (247 [ps]) of the macro 70 of the line 17b-4 is longer than the delay time (167 [ps]) of the macro 70 in the timing verification error report 17a by 80 [ps], which is equivalent to the delay time within the macro. Because the line 17b-10 is given by a sum of the delay time of the lines 17b-4 to 17b-7, the signal pass delay time Td becomes 1047 [ps], which is 80 [ps] longer than the value (967 [ps]) of the operation timing report 17a in this exemplary embodiment.

In the related art, the clock distribution delay time within the macro 70 is included in the value of the delay time table 131b, given as the delay time of the macro 70, and is not considered in the calculation of a clock skew. That is, the clock skew Ts is given as a difference between the clock delay time Tc1 of the macro 70 and the clock delay time Tc2 of the cell 51a. Because the clock delay time Tc1 of the macro 70 is 10 [ps] and the clock delay time Tc2 of the cell 51a is 90 [ps], the clock skew Ts of the line 17b-2 of the timing verification error report in the related art becomes 10−90=−80 [ps].

The signal pass demand delay time Tr of the line 17b-9 is a value obtained by subtracting a sum of the clock skew Ts of the line 17b-2 and the setup time Tsu of the line 17b-3 from the clock cycle time T of the line 17b-1 and becomes 1000−(−80+40)=1040 [ps]. The slack of the line 17b-11 is a value obtained by subtracting the signal pass delay time Td of the line 17b-10 from the signal pass demand delay time Tr of the line 17b-9 and becomes 1040−1047=−7 [ps].

A comparison between the timing verification error report of FIG. 15 and the timing verification error report of FIG. 16 reveals that the value of the slack to be referred to in making a judgment as to whether or not an operation timing violation has occurred, is the same value (−7 [ps]). Therefore, for this unit it is judged that a delay improvement is necessary in both the timing verification error report 17a in this exemplary embodiment and the timing verification error report 17b in the related art. There are two methods of making delay improvements: a method of improving the delay time of a signal path and a method of improving a clock skew. When the timing verification error report 17a in this exemplary embodiment is referred to, the clock skew Ts is found to be 0 [ps]. Therefore, it is necessary only that the delay time of a signal path be improved.

On the other hand, when the timing verification error report 17b in the related art is referred to, the clock skew Ts is found to be −80 [ps]. Therefore, it is judged that a clock skew improvement is necessary. In actuality, however, the clock skew is good (i.e., nonexistent) when the clock delay time within the macro 70 is also considered. Thus, in the timing verification error report 17b in the related art, even when the clock distribution is actually in a good condition, it appears as if an improvement in the clock distribution is necessary, with the result that it is difficult to rapidly make an appropriate improvement.

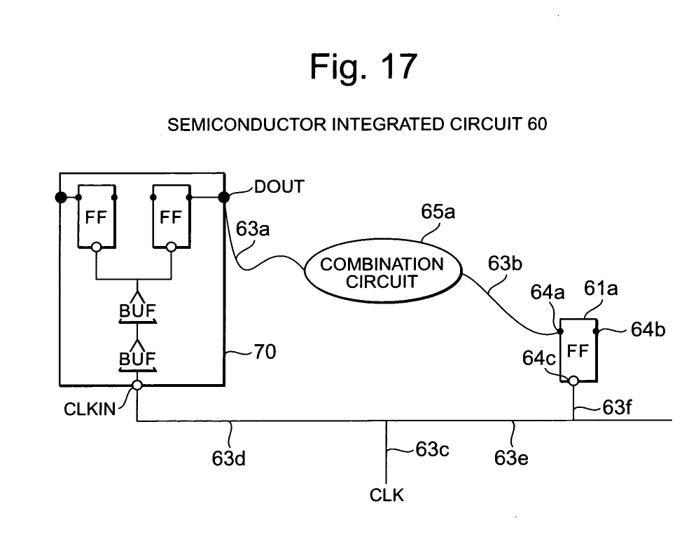

Subsequently, FIG. 17 shows another example of a semiconductor integrated circuit to be verified. This semiconductor integrated circuit 60 includes a macro 70, a cell 61a, interconnects 63a to 63f, and a combination circuit 65a. The configuration of the macro 70 is the same as the configuration shown in FIG. 3. The cell type of the cell 61a is a flip-flop (FF). The cell 61a has an input terminal 64a, an output terminal 64b and a clock terminal 64c. A signal outputted from an output terminal DOUT of the macro 70 is inputted to the input terminal 64a of the cell 61a via the interconnect 63a, the combination circuit 65a and the interconnect 63b. The operation timing verification of the semiconductor integrated circuit 60 will be described below by using examples of concrete numerical figures.

At Step S2, the delay time calculation unit 21 performs a delay time calculation by using the circuit net list 11 of the semiconductor integrated circuit 60, the cell library 12 and the macro delay library 13, and stores the SDF 14 in the SDF storage section 34. For the macro 70, the delay time of the macro 70 is 167 [ps] from an input waveform rounding of the macro 70 of “0.2R” and an output load capacity of “0.2C” by referring to the delay time table 131a. This delay time is a value not including the macro delay time within the macro 70. The delay time of each part, including the delay time of the macro 70 of “167 [ps],” is described in the SDF 14.

The delay time analysis unit 22 obtains the delay time of the macro 70, which is a start-point block, the delay time of the interconnects 63a, 63b, and the delay time of the combination circuit 65a by referring to the SDF 14, and calculates the signal delay time Td from the macro 70 to the cell 61a. If the delay time of the interconnect 63a is 10 [ps], the delay time of the combination circuit 65a is 710 [ps], and the delay time of the interconnect 63b is 10 [ps], then the signal delay time Td is a sum of the delay time of these and the delay time of the macro 70. Thus, the signal delay time Td is 897 [ps].

At Step S5, the timing analysis unit 22 calculates the clock skew Ts. The clock delay time Tc1 that elapses until a clock signal reaches the clock terminal CLKIN of the macro 70 is a sum of the interconnect delay time of the interconnects 63c, 63d. The interconnect delay time of the interconnects 63c, 63d can be obtained by referring to the SDF 14. In this case, it is assumed that a sum of the interconnect delay time of the interconnects 63c, 63d, i.e., the clock delay time Tc1 is 10 [ps]. The clock delay time Tc2 that elapses until a clock signal reaches the clock terminal 64c of the cell 61a is a sum of the interconnect delay time of the interconnects 63c, 63e, 63f. Also the interconnect delay time of the interconnects 63c, 63e, 63f can be obtained from the SDF 14. In this case, it is assumed that a sum of the interconnect delay time of the interconnects 63c, 63e, 63f, i.e., the clock delay time Tc2 is 10 [ps].

The timing analysis unit 22 finds the clock delay time from the clock terminal CLKIN of the macro 70 to the clock terminal 76j of the FF cell 73b on the output terminal DOUT side by referring to the macro clock delay library 16 (FIG. 12). In the macro clock delay library 16 shown in FIG. 12, the line 16-2 describes the clock delay time to the clock terminal 76j of the FF cell 73b, the value of which is 80 [ps]. Because the clock delay time Tc1 to the macro 70 is 10 [ps], the clock delay time within the macro 70 is 80 [ps], and the clock delay time of the cell 61a is 10 [ps], the clock skew Ts becomes (10+80)−10=80 [ps]. This clock skew is an actual clock skew (i.e., a clock skew calculated by using the clock delay time in which the clock distribution delay within the macro 70 is considered).

At Step S6, the timing analysis unit 22 performs operation timing verification by using the signal pass delay time Td and the clock skew Ts. In the setup verification, first, the signal pass demand delay time Tr is found, which is a value obtained by subtracting a sum of the clock skew Ts and the setup time of the cell 61a from the clock cycle time of the clock signal CLK. If the clock cycle time is 1000 [ps], then the clock skew Ts is 80 [ps] and the setup time of the cell 61a is 40 [ps], then the signal pass demand time Tr becomes 1000−(80+40)=880 [ps]. Subsequently, a slack obtained by subtracting the signal pass delay time Td from the signal pass demand delay time Tr is found. Because the signal pass delay time Td is 897 [ps], the slack becomes 880−897=−17 [ps].

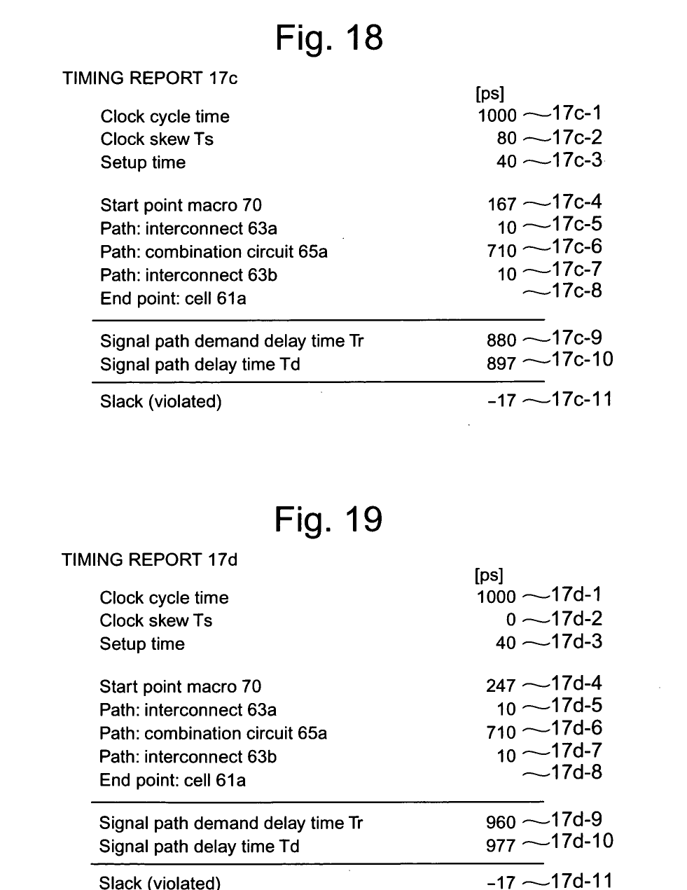

At Step S7, the timing analysis unit 22 outputs a timing verification error report. FIG. 18 shows a timing verification error report. The line 17c-1 describes the clock cycle time (1000 [ps]), and the line 17c-2 describes the clock skew Ts (80 [ps]) calculated at Step S5. The line 17c-3 describes the setup time (40 [ps]) of the cell 61a. The lines 17c-4 to 17c-8 describe signal paths from the macro 70, which is a start-point block, to the cell 61a, which is an end-point block.

The line 17c-4 describes the delay time (167 [ps]) of the macro 70, the line 17c-5 describes the delay time (10 [ps]) of the interconnect 63c, the line 17c-6 describes the delay time (710 [ps]) of the combination circuit 65a, and the line 17c-7 describes the delay time (10 [ps]) of the interconnect 63b. The line 17c-10 describes the signal pass delay time Td (897 [ps]) calculated at Step S4. The line 17c-9 describes the signal pass demand delay time Tr (880 [ps]) obtained by subtracting a sum of the clock skew Ts of the line 17c-2 and the setup time Tsu of the line 17c-3 from the clock cycle time T of the line 17c-1. The line 17c-11 describes a slack (−17 [ps]) obtained by subtracting the signal pass delay time Td from the signal pass demand delay time Tr of the line 17c-9.

As a comparative example, the operation timing verification of the semiconductor integrated circuit 60 was carried out by applying the related art. FIG. 19 shows a timing verification error report, which is the result of an operation timing verification in the related art. The clock cycle time T of the line 17d-1 and setup time Tsu of the line 17d-3 in the timing verification error report 17d have the same values as in the timing verification error report 17c of this exemplary embodiment shown in FIG. 18. Also, the delay time of the lines 17d-5 to 17d-7 has the same values as in the timing verification error report 17c.

In the related art, in the delay time calculation of the macro 70, the delay time table 131b (FIG. 6) that holds the delay time including the clock delay time (80 [ps]) within the macro 70 is referred to. When the delay time table 131b is referred to at an input waveform rounding of “0.2R” and an output load capacity of “0.2C,” the delay time of the macro 70 becomes 247 [ps]. Therefore, the line 17d-4 describes the delay time (247 [ps]), which is longer than the delay time (167 [ps]) of the macro 70 in the timing verification error report 17c by 80 [ps], which is equivalent to the delay time within the macro, as the delay time of the macro 70. Because the line 17d-10 is given by a sum of the delay time of the lines 17d-4 to 17d-7, the signal pass delay time Td becomes 977 [ps], which is 80 [ps] longer than the value (897 [ps]) of the operation timing report 17c in this exemplary embodiment.

In the related art, the clock distribution delay time within the macro 70 is included in the value of the delay time table 131b, given as the delay time of the macro 70, and is not considered in the calculation of a clock skew. That is, the clock skew Ts is given as a difference between the clock delay time Tc1 of the macro 70 and the clock delay time Tc2 of the cell 61a. Because the clock delay time Tc1 of the macro 70 is 10 [ps] and clock delay time Tc2 of the cell 61a is 10 [ps], the clock skew Ts of the line 17d-2 of the timing verification error report in the related art becomes 0 [ps].

The signal pass demand delay time Tr of the line 17d-9 is a value obtained by subtracting a sum of the clock skew Ts of the line 17d-2 and the setup time Tsu of the line 17d-3 from the clock cycle time T of the line 17d-1 and becomes 1000−(0+40)=960 [ps]. The slack of the line 17d-11 is a value obtained by subtracting the signal pass delay time Td of the line 17d-10 from the signal pass demand delay time Tr of the line 17d-9 and becomes 960−977=−17 [ps].

A comparison between the timing verification error report 17c of FIG. 18 and the timing verification error report 17d of FIG. 19 reveals that the value of the slack to be referred to in making a judgment as to whether or not an operation timing violation has occurred, is the same value (−17 [ps]). Therefore, for this unit it is judged that a delay improvement is necessary in both the timing verification error report 17c in this exemplary embodiment and the timing verification error report 17d in the related art. When the timing verification error report 17c in this exemplary embodiment is referred to, the clock skew Ts is found to be 80 [ps]. Therefore, it is apparent that the clock skew only needs to be improved.

On the other hand, when the timing verification error report 17d in the related art is referred to, the clock skew Ts is found to 0 [ps]. Therefore, it is judged that an improvement in the delay time of a signal path is necessary. In actuality, however, the clock skew is 80 [ps] and hence unsatisfactory when the clock delay time within the macro 70 is also considered.

Thus, in the timing verification error report 17d in the related art, even when the clock distribution is actually in a bad condition, it appears as if an improvement in the clock distribution were unnecessary, with the result that it is difficult to rapidly make an appropriate delay improvement.

In this exemplary embodiment, in the operation timing verification of a signal in which at least either a start-point block or an end-point block is a macro, a clock skew is calculated by using the delay time calculated by the delay calculation unit 21 and a macro clock delay library that describes the clock delay time within the macro.

More specifically, a clock skew is calculated by using a value obtained by adding the clock delay time within the macro, which is described in the macro clock delay library, to the clock delay time from a source clock to a clock terminal of the macro, which is calculated by the delay time calculation unit 21. A true clock skew in which the clock distribution delay within the macro 70 is considered can be obtained by this method.

When an operation timing violation occurs in the operation timing verification, a clock skew improvement is necessary in the case of a large clock skew, whereas it is necessary to improve the delay time of a signal pass in the case of a small clock skew.

In the present invention, a clock skew in which the clock distribution delay time within the macro is obtained. Therefore, when an operation timing violation occurs, it is possible to make a correct judgment as to whether a clock distribution improvement is necessary or a signal delay time improvement is necessary. In general, if a clock distribution is corrected, this has an effect on the delay results of all passes present before and behind the clock. Therefore, a clock distribution should be avoided as far as possible. In that sense also, a great advantage is provided in the design of a semiconductor integrated circuit by the fact that whether a clock distribution is satisfactory or not can be easily judged by referring to the clock skew information of the timing verification error report.

Incidentally, in the foregoing, the description was given of a concrete example of the setup verification of a signal pass in which the start-point block is a macro and the end-point block is an FF. However, the present invention is not limited to this. Also, in a signal pass in which the start-point block is a cell such as an FF and the end-point block is a macro or in a signal pass in which the start-point block is a macro and the end-point block is a macro, a clock skew in which the clock distribution delay within the macro is calculated by using a technique similar to the above-described technique and it is possible to perform operation timing verification using the clock skew. In the setup timing analysis/hold timing analysis of a signal pass in which a macro is an end-point block, the setup time/hold time of the macro can be obtained from the setup time table 133a (FIG. 8)/hold time table 134a (FIG. 10).

In the above-described exemplary embodiment, the delay time table 131a (FIG. 5) in which the clock distribution delay time within the macro is excluded is prepared and the clock signal delay time of the macro not including the clock distribution delay time is calculated by referring to this delay time table 131a. However, a delay time calculation of a macro is not limited to this. For example, it is also possible to adopt a method that involves calculating the delay time of a macro by referring to the delay time table 131a including the clock distribution delay time, which is used in the related art, and thereafter calculating the signal delay time of the macro not including the clock distribution delay time by subtracting the clock distribution delay time within the macro from the calculated delay time by referring to the macro clock delay library. In this case, it is unnecessary to prepare the delay time table 131a in which the clock distribution delay time is excluded.

The present invention was described above on the basis of an exemplary embodiment. However, the apparatus, method and program for verifying operation timing of the present invention are not limited to the above-described exemplary embodiment alone, and also various modifications and changes made in the configuration of the above-described exemplary embodiment are included in the scope of the present invention.

Further, it is noted that applicant's intent is to encompass equivalents of all claim elements, even if amended later during prosecution.

What is claimed is:

1. An apparatus, comprising:
an analyzing unit which simulates a clock skew of a circuit including a macro block, said macro block comprising a circuit element; and
a macro clock delay store element which stores a macro clock delay corresponding to said macro block, said macro clock delay indicating a delay of a clock signal passing through said macro block,
wherein said analyzing unit simulates said clock skew of said circuit by using said macro clock delay.

2. The apparatus according to claim 1, wherein said circuit comprises said macro block and a circuit cell, said circuit cell operating relative to said macro block, and
wherein said analyzing unit simulates said clock skew of a signal path between said macro block and said circuit cell.

3. The apparatus according to claim 2, further comprising:
a clock delay store element which stores a first clock delay indicating a delay of said clock signal between a clock signal source and said macro block, and a second clock delay indicating a delay of said clock signal between said clock signal source and said circuit cell,
wherein said analyzing unit simulates said clock skew based on said macro clock delay, said first clock delay, and said second clock delay.

4. The apparatus according to claim 3, wherein said analyzing unit simulates said clock skew by adding said macro clock delay and said first delay for generating a total macro clock delay, and subtracting said second clock delay from said total macro clock delay.

5. The apparatus according to claim 2, further comprising:
a circuit cell delay store element which stores a circuit cell delay indicating a delay caused by said circuit cell;
a macro delay store element which stores a macro delay indicating a delay of a data signal passing through said macro block; and
a delay calculator which calculates a general delay of said circuit based on said circuit cell delay and said macro delay, said general delay indicating a delay caused by said circuit,
wherein said analyzing unit simulates an operation of said circuit based on said general delay and said clock skew.

6. The apparatus according to claim 5, wherein said macro clock delay and said macro delay are stored separately from each other.

7. A system, comprising:
an analyzing unit which simulates a clock skew of a circuit including a macro block, said macro block comprising a circuit element; and
a macro clock delay store element which stores a macro clock delay corresponding to said macro block, said macro clock delay indicating a delay of a clock signal passing through said macro block,
wherein said analyzing unit simulates said clock skew of said circuit by using said macro clock delay.

8. The system according to claim 7, wherein said circuit comprises said macro block and a circuit cell, said circuit cell operating relative to said macro block, and
wherein said analyzing unit simulates said clock skew of a signal path between said macro block and said circuit cell.

9. The system according to claim 8, further comprising:
a clock delay store element which stores a first clock delay indicating a delay of said clock signal between a clock signal source and said macro block, and a second clock delay indicating a delay of said clock signal between said clock signal source and said circuit cell,
wherein said analyzing unit simulates said clock skew based on said macro clock delay, said first clock delay, and said second clock delay.

10. The system according to claim 9, wherein said analyzing unit simulates said clock skew by adding said macro clock delay and said first delay for generating a total macro clock delay, and subtracting said second clock delay from said total macro clock delay.

11. The system according to claim 8, further comprising:
a circuit cell delay store element which stores a circuit cell delay indicating a delay caused by said circuit cell;
a macro delay store element which stores a macro delay indicating a delay of a data signal passing through said macro block; and
a delay calculator which calculates a general delay of said circuit based on said circuit cell delay and said macro delay, said general delay indicating a delay caused by said circuit,
wherein said analyzing unit simulates an operation of said circuit based on said general delay and said clock skew.

12. The system according to claim 11, wherein said macro clock delay and said macro delay are stored separately from each other.

13. A method of verifying an operation of a circuit including a macro block which comprises a circuit element, comprising:
referring to a macro clock delay corresponding to said macro block, said macro clock delay indicating a delay of a clock signal passing through said macro block; and
simulating a clock skew of said circuit by using said macro clock delay.

14. The method according to claim 13, wherein said simulating said clock skew comprises simulating said clock skew of a signal path between said macro block and a circuit cell, said circuit cell operating relative to said macro block.

15. The method according to claim 14, further comprising:
referring to a first clock delay indicating a delay of said clock signal between a clock signal source and said macro block, and a second clock delay indicating a delay of said clock signal between said clock signal source and said circuit cell; and
wherein said simulating said clock skew comprises simulating said clock skew based on said macro clock delay, said first clock delay, and said second clock delay.

16. The method according to claim 15, wherein said simulating said clock skew comprises simulating said clock skew by adding said macro clock delay and said first delay for generating a total macro clock delay, and subtracting said second clock delay from said total macro clock delay.

17. The method according to claim 14, further comprising:
referring to a circuit cell delay indicating a delay caused by said circuit cell;
referring to a macro delay indicating a delay of a data signal passing through said macro block;
calculating a general delay of said circuit based on said circuit cell delay and said macro delay, said general delay indicating a delay caused by said circuit; and
simulating said operation of said circuit based on said general delay and said clock skew.

18. The method according to claim 17, wherein said macro clock delay and said macro delay are stored separately from each other.
